(19) United States
(12) Patent Application Publication
(10) Pub. No.: US 2012/0150999 A1
(43) Pub. Date: Jun. 14, 2012

(54) ACCESS OF MEDIA CONTENT VIA MEDIA COMMUNICATION SYSTEM

(75) Inventors: Martin Svensson, Goteborg (SE); Mathias Kleverud, Goteborg (SE)

(73) Assignee: SAGASTREAM AB, GOTEBERG (SE)

(21) Appl. No.: 13/392,513

(22) PCT Filed: Aug. 25, 2009
(86) PCT No.: PCT/SE09/50949

§ 371 Date: Feb. 24, 2012

(51) Int. Cl. G06F 15/16

(52) U.S. Cl. 709/217

(57) ABSTRACT

Disclosed herein is a method, a control node 40 and a client device 10b for providing a playable media content to the client device. The method comprises the steps of sending a request for a media content 32b from the client device to the control node, determining in the control node one or several suitable version 32b1, 32bn of the requested media content, receiving in the client device from the control node arrangement information indicating said determined version, selecting in the client device one of the determined versions, sending a request for the selected version from the client device to a media node arrangement 30b, and receiving in the client device from the media node a playable form of the selected version.

### TECHNICAL FIELD

The present invention relates to media communication systems and to a method for obtaining and playing media content in media communication systems.

### BACKGROUND OF THE INVENTION

FIG. 1 illustrates a known media communication system 100 in which a client device 10a requests and receives media content via a media communication network arrangement 50a by interacting with a server node arrangement 20 and a media node arrangement 30a.

In operation, the client device 10a may use suitable software for accessing an information resource unit 23 in the server node arrangement 20, e.g. accessing as a web-page of a web-site hosted by the server node arrangement 20; see arrow 12 extending from the device 10a to the server node arrangement 20 in FIG. 1. The server node arrangement 20 may reply and return information to the device 10a relating to the accessed information resource unit 23; see arrow 14 extending from the server node arrangement 20 to the client device 10a in FIG. 1. The returned information may cause the device 10a to request a certain media content from the media node arrangement 30a; see arrow 16 extending from device 10a to media node 30a in FIG. 1. The media node arrangement may reply and return the requested media content to the device 10a; see arrow 18 extending from media node 30a to device 10a in FIG. 1.

The structure and function of systems such as the system 100 described above are well known to those skilled in the art and they need no detailed description. However, a few remarks are made below.

The client device 10a in FIG. 1 may e.g. be a Personal Computer (PC) having a broadband access capability allowing access to the World Wide Web (the web) or similar, e.g. via the Internet or similar. In addition to an operating system (OS) there may be other software applications installed on a typical client device, e.g. such as word processing, spreadsheets, databases, web-browsers etc.

It is particularly preferred that a web-browser or a similar browser is installed on the client device 10a. The browser enables the client device 10a to interact with text, images, videos, music, games and other information located on an information resource unit, e.g. such as web-page hosted by the server node 20. As already indicated, a web-page may contain links to other web-pages at the same or different web-site. A web-browser allows a user to access information provided on many web-pages at many web-sites by traversing these links. Well known web-browsers for the Internet and Intranets are e.g. the Internet Explorer (provided by Microsoft Corporation), the Mozilla Firefox (provided by Mozilla Corporation) and Safari (provided by Apple Inc.).

In addition, the server node arrangement 20 may e.g. be implemented as a computer running suitable software 22. The node arrangement 20 may e.g. be a part of the network 50a or accessible via the network 50a. As previously indicated it is assumed that the server node arrangement 20 comprises a plurality of information resource units 23. The server node arrangement 20 may e.g. comprise a plurality of web-pages. It may be clarified that a web-page may be regarded as an information resource unit that is suitable for the World Wide Web or similar. The web-page resource information is usually in HTML format or similar (e.g. XHTML), and may provide navigation to other web-pages via hypertext links or similar. Web-pages may e.g. be accessed from a local computer (e.g. the device 10a) or from a remote web-server. Typically the server node arrangement 20 operates by accepting HTTP (Hypertext Transfer Protocol) requests or similar from the client device 10a, and by providing HTTP responses or similar to the device 10a. An HTTP response usually consists of an HTML (HyperText Markup Language) document, but it may also be a raw file, an image, or some other type of web-content or similar.

Moreover, the media node arrangement 30a may e.g. be implemented as a simple storage device, or as a media center PC running Windows XP Media Center Edition, MediaPortal or MythTV or similar, or as a commercial web-sever that hosts media content for a large web site. The media node 30a may e.g. be a part of the network 50a or accessible via the network 50a. As previously indicated it assumed that the media node arrangement 30a comprises a plurality of media content 32. A media content 32 may e.g. be a music piece, an image or a movie or similar content that can be audible and/or visible reproduced to a user of the system 100.

It should also be explained that the communication network 50a may be the Internet or some other network arrangement that uses the Internet Protocol (IP) or similar. The properties of the Internet are well known to those skilled in the art and no detailed description is needed. The client device 10a may access the network 50a in substantially any manner, e.g. via copper lines, optical fiber or radio communication or any other suitable communication media. Preferably the access provides broadband communication with a bandwidth of several Mega bits per second (Mbit/s) or more, particularly in the downlink direction to the client device 10a.

In the media communication system 100 and other known media communication systems it is difficult to control the desired variation in the replies from a Media Node, e.g. such as the node 30a. This is particularly so if the desired variation depend on the properties of a server node (e.g. such as a web-page hosted by the node 20) being accessed and/or the properties of the client device in question. Such properties are not easily controlled in an efficient manner, e.g. changed, modified or varied or similar by e.g. additions, deletions or substitutions or similar. This is especially so if the person or entity whishing to control the desired variations in the replies from the Media Node does not control the server node and/or the client device.

For example, the reply to the device 10a from the server node arrangement 20 may comprise old information which may cause the device 10a to request certain media content from an obsolete and/or inactive address or source, e.g. such as a deleted media content 32a previously comprised by the node 30a. Similarly, the information in the reply from the server node arrangement 20 may be insufficient and cause the client device to request and obtain a less suitable version of a requested media content.

To mitigate the problem of unsuitable media content the Media Nodes in prior art solutions may use transcoding of the requested media content. The transcoding can be seen as a tailoring of the requested media content to a form that is appropriate to be played by the requesting client device. Typically, the media content provided by the Media Node is transcoded in the Media Node as it is transmitted (e.g. streamed) to the client device for display. This may be fairly satisfactory when media content is an uncomplicated web-page being tailored by a single process. However, it will be increasingly demanding on the Media Node when a web-page is simultaneously tailored by several processes to fit several requesting terminals of different types. It will be even more demanding if the media content is a video (typically a data file of several Megabytes or even Gigabytes) or similar that is simultaneously tailored by several processes for streaming or similar to several requesting terminals of different types. In addition, even if a transcoding or similar is possible there may still be insufficient information for the transcoding to produce the most suitable version of the requested media content.

It should also be noted that a possible transcoding does not offer any mechanism for controlling the desired variations in the reply from Media Node, particularly not so as to avoid accessing obsolete and/or inactive media content and/or web pages or other recourses.

Thus there is a need for an improved scheme for requesting and receiving media content via a media communication network arrangement, wherein the received version or similar of the media content is more appropriate for being played on the requesting client device.

### SUMMARY OF THE INVENTION

At least one of the drawbacks discussed above have been eliminated or at least mitigated by a first embodiment of the present invention being directed to a method for providing playable media content to a client device.

The method comprises the steps of: sending a request for a media content from the client device to a control node arrangement; determining in the control node arrangement one or several suitable version of the requested media content; receiving in the client device from the control node arrangement information indicative of said determined version; selecting in the client device one of the determined versions; sending a request for the selected version from the client device to a media node arrangement; and receiving in the client device from the media node arrangement a playable form of the selected version.

Involving a control node for providing available and suitable versions of a requested media content increases the probability that the client device will obtain the most suitable version of the requested media content. For example, it reduces the risk that the client device requests a version from an obsolete and/or inactive address or inactive source (e.g. an obsolete media content address comprised by a web page), since the address of the media content and/or the media content versions may be appropriately updated at one central place, i.e. in the control node arrangement as the address or source changes.

In addition, making a selection In the client device enables the client device to make a more precise selection of a suitable version of a requested media content. This is particularly advantageous in case the client device has access to and/or comprise information that is not available to the control node and/or the media node, or information that has not been properly considered by the control node and/or the media node when determining ant providing said versions and playable form.

Furthermore, the method may comprise the steps of: sending a request for a media player from the client device to the control node arrangement such that the request comprises the information items and/or information indicative of the properties of the client device; determining a media player in the control node arrangement based on said information items and/or said properties; receiving in the client device the determined media player from the control node arrangement.

This makes it possible to determine a media player that is particularly advantageous for playing the requested media content so as to make the received version or similar of the media content more appropriate for being played on the requesting client device.

In addition, at least one of the drawbacks discussed above have been eliminated or at least mitigated by another embodiment of the present invention being directed to a client device configured to operatively play media content. The client device is configured to operatively: send a request for a media content to a control node arrangement; receive information from the control node arrangement indicating one or several suitable version of the requested media content; select one of the indicated suitable versions; send a request for the selected version to a media node arrangement; and receive a playable form of the selected version from the media node arrangement.

In addition, at least one of the drawbacks discussed above have been eliminated or at least mitigated by another embodiment of the present invention being directed to a control node arrangement configured to operatively provide information to a client device indicative of versions of a media content. The control node arrangement is configured to operatively: receive a request for a media content from the client device; determining one or several suitable version of the requested media content; send information to the client device indicative of the determined suitable versions.

It should be emphasized that the term “comprises/comprising” when used in this specification is taken to specify the presence of stated features, integers, steps or components, but does not preclude the presence or addition of one or more other features, integers, steps, components or groups thereof.

Similarly, the steps of the methods described herein must not necessarily be executed in the order in which they appear and embodiments of said methods may comprise more or less steps without falling outside the scope of the present invention.

Further advantages and advantageous features of the invention are disclosed in the following description and in the dependent claims.

### BRIEF DESCRIPTION OF THE DRAWINGS

A more detailed description of the present invention is given below with reference to a plurality of exemplifying embodiments as illustrated in the appended figures, wherein:

FIG. 1 illustrates a known media communication system 100,

FIG. 2 illustrates a media communication system 200 according to an embodiment of the present invention,

FIG. 3 is a sequence diagram illustrating the steps of an embodiment of the present invention,

FIG. 4 is showing a flowchart illustrating the steps of an embodiment of the present invention.

### DETAILED DESCRIPTION OF PREFERRED EMBODIMENTS

### Structure of an Exemplifying Media Communication System

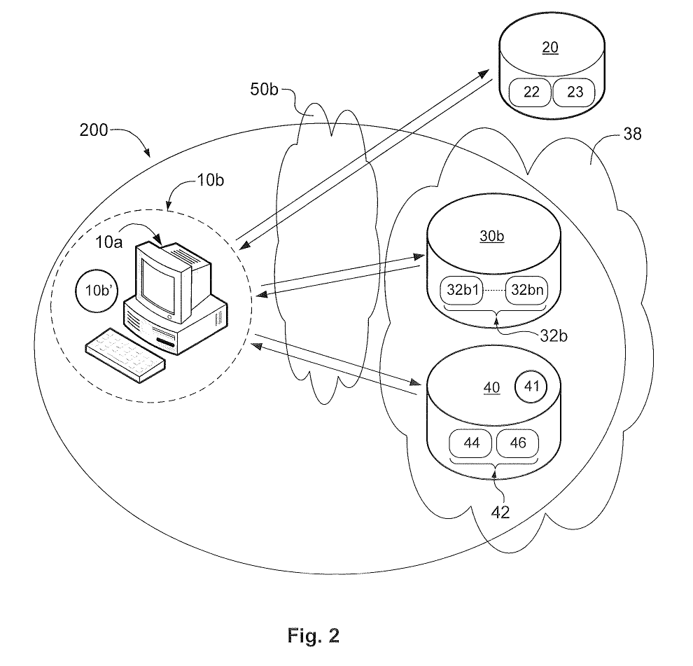

FIG. 2 illustrates a media communication system 200 according to an embodiment of the present invention. It is preferred that the system 200 comprises at least one client device 10b, at least one media node arrangement 30b and a control node arrangement 40.

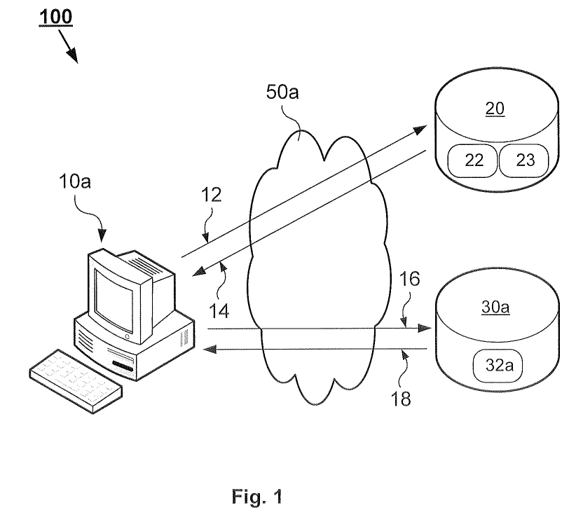

The media communication system 200 allows the client device 10b, the media node arrangement 30b and the control node arrangement 40 to operatively interact so as to play requested media content on the client device 10b. Preferably, the client device 10b communicates with the media node arrangement 30b and the control node 40 via a communication network arrangement 50b. The network arrangement 50b may be of any suitable kind, e.g. of the same or similar kind as the known communication network arrangement 50a previously described with reference to FIG. 1. In other words, the network arrangement 50b may e.g. be the Internet or any similar communication network utilising packet based communication.

The client device 10b in FIG. 2 may be based on substantially any device that is configured to operatively access the communication network arrangement 50b. Thus the client device 10b may e.g. be based on an Internet-ready phone (e.g. a cell phone or similar), or a personal digital assistant (PDA), or a hand-held computer, or a Personal Computer (PC), or a WebTV, or a video game console (e.g. such as the PlayStation 3, Wii, and Xbox 360) or any other device providing access to the Internet and the World Wide Web or similar communication network arrangement. Preferably the client device 10b is configured to provide a broadband communication to the communication network 50b having a bandwidth of several Mega bits per second (Mbit/s) or more. This is particularly so in the downlink direction to the client device 10b. It is also preferred that the client device 10b is configured to browse the communication network 50b to which it may be connected, e.g. configured to browse the Internet or similar. The browsing or similar may e.g. be implemented by means of software 10b′ being loaded into the hardware of the client device 10b. The software 10b′ may e.g. comprise a browser such as a web-browser or similar and possibly also other software components that may interact with the browser component. The hardware of the device 10b may e.g. the known client device 10a as previously described in the Background Section.

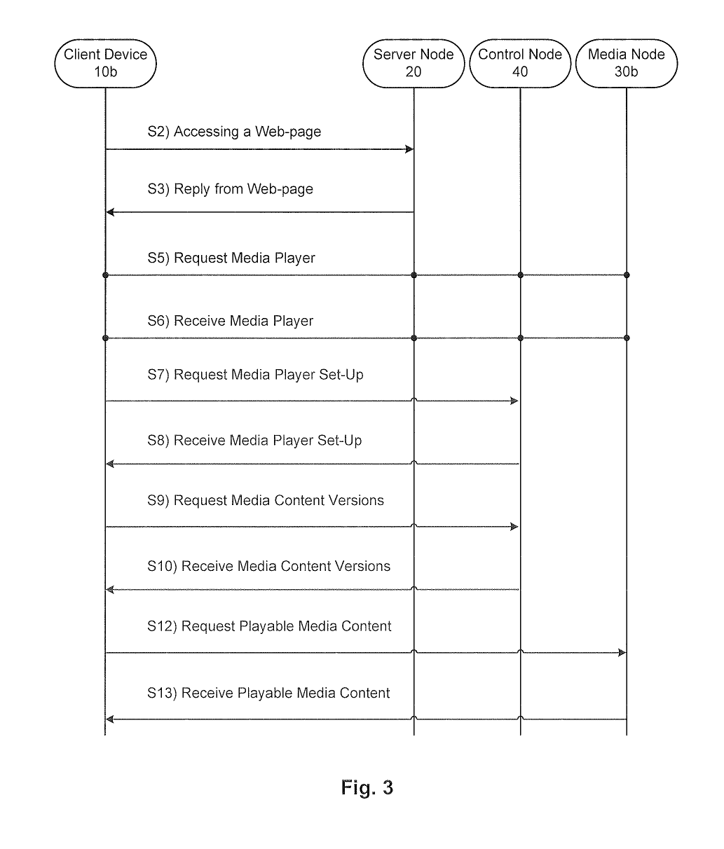

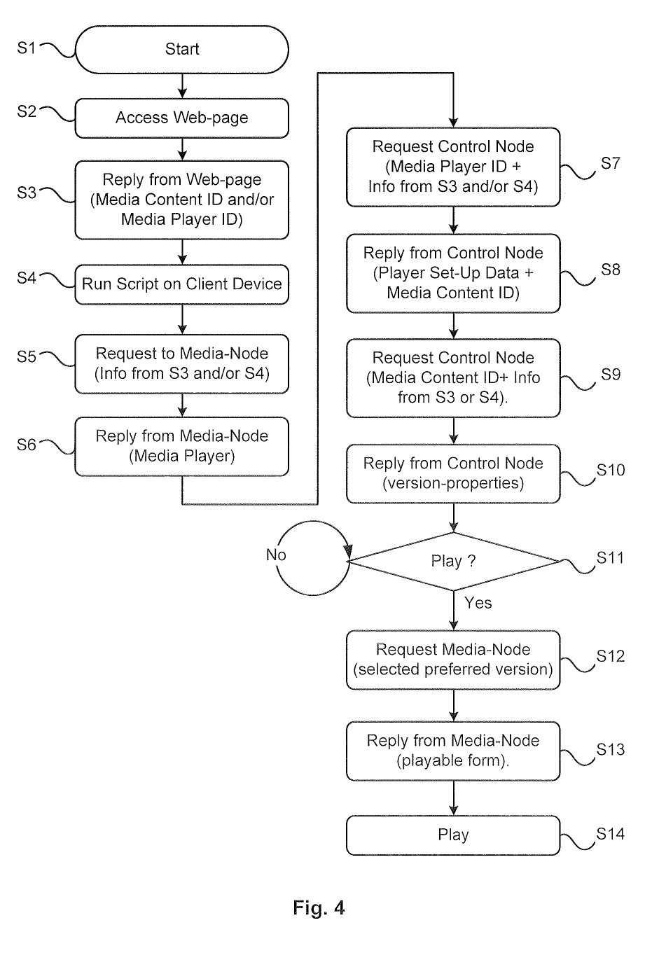

In operation, the client device 10b may use the software 10b′ to access a server node arrangement 20 via the network arrangement 50b in a similar manner as previously described with reference to the client device 10a and the server node arrangement 20 in FIG. 1. Thus, the client device 10b may e.g. access a web-page of a web-site hosted by the server node arrangement 20, whereby the server node arrangement 20 may return information relating to the accessed web-page. The received information may then cause the client device 10b to request certain media content by interacting with the media node arrangement 30b and the control node arrangement 40 as will be described in further detail later with reference to FIGS. 3 and 4.

The client device 10b has now been described in some detail and the attention is directed to the media node arrangement 30b in FIG. 2. The media node arrangement 30b may be implemented by means of a simple storage device, or as a media center PC running Windows XP Media Center Edition, MediaPortal or MythTV, or as a commercial web-sever that hosts media content for a large web site or by means of any other media storage device configured to be accessible by the client device 10b via the network 50b. The media node arrangement 30b may be a part of the network 50b and/or accessible via the network 50b.

It is preferred that the media node arrangement 30b comprises a plurality of media contents 32b that can be requested by the client device 10b. It is also preferred that the media node arrangement 30b comprises one or several versions 32b1 to 32bn of each media content 32b. The media content 32b may e.g. be a music piece, an image or a movie or similar audible and/or visible content. The versions of a media content 32b may e.g. provide the requested media content 32b in different forms, e.g. in different resolutions, in different file formats, as associated pre-views and/or thumbnails or similar.

It should be emphasised that the communication system 200 may comprise one or several media node arrangements of the same or similar type as the media node arrangement 30b. It is assumed that these media nodes can be accessed by the client device 10b via the communication network arrangement 50b and that these media nodes can be controlled by the control node arrangement 40 as will be further described below.

The control node arrangement 40 in FIG. 2 may be implemented by means of a server arrangement based on a PC or any other suitable computer arrangement or similar configured to be accessible by the client device 10b. It is preferred that the control node arrangement 43b is configured to control the request and playing of media content 32b made by the client device 10b. The control function of the control node arrangement 40 is preferably implemented by a software arrangement 42 being loaded into the hardware of the control node arrangement 40. The software arrangement 42 may e.g. comprise one or several executable software components 44 that may interact with each other. The software arrangement 42 may also comprise one or several databases or similar information carrying units 46 configured to interact with and provide information to the software component(s) 44 when the control node arrangement 40 performs its control functions.

The information carrying unit 46 may e.g. comprise such information that is received by the client device 10b from the control node arrangement 40 as will be described later with reference to FIGS. 3 and 4.

This information may e.g. comprise knowledge about the version-properties of the various available versions 32b1 to 32bn of requested media content 32b that is comprised by the media node arrangement 30b. The version-properties may e.g. comprise the address, the name, the file name, the file type, the file size, the supported image resolution and other properties of the versions 32b, 32bn such that the version can be identified and retrieved from the media node arrangement 30b. The information may also comprise knowledge about e.g. the properties (subscription profile) of a number of accessible information resource units 23 such as web-pages or similar (a web-page may be identified by its URL). The effect may be that if certain web-pages have been accessed then certain media content (i.e. a certain version of a certain media content) will be downloaded, e.g. if a certain location is reported for the client device 10b then a certain media content may be provided or if a certain web-page has been accessed then a certain file format may be provided for the media content (e.g. premium quality or low quality).

The media node arrangement 30b and the control node arrangement 40 may be seen as functional or virtual units being implemented by means of a computer cloud 38. The computer cloud 38 can be seen as a parallel and distributed system comprising a collection of interconnected and virtualised computers (e.g. comprising the hardware of one or several media node arrangements 30b and the control node arrangement 40) that are dynamically provisioned and presented as a unified computing resources to a client device (e.g. the client device 10b). Here it should be emphasized that the media communication system 200 may comprise several media node arrangements 30b. The media node arrangements 30b may be arranged in one or several computer clouds and a single media node arrangement 30b may be distributed over a plurality of computer clouds.

### Function of an Exemplifying Media Communication System

The attention is now directed to an exemplifying method according to an embodiment of the present invention. The steps of the exemplifying method are described with reference to FIG. 3 showing a sequence diagram, and with reference to FIG. 4 showing a flowchart. It is assumed that the exemplifying method is performed by one or several entities in the media communication system 200 representing an embodiment of the present invention. However, the exemplifying method may be performed by other media communication systems configured according to an embodiment of the present invention.

In a first step S1 of the exemplifying method it is preferred that the media communication system 200 has been activated. Thus, it is preferred that the client device 10b, the media node arrangement 30b and the control node arrangement 40 have been configured and activated such that they can operatively interact to play requested media content on the client device 10b.

In a second step S2 of the exemplifying method it is preferred that the client device 10b accesses an information resource unit 23, e.g. accesses a Web-page comprised by the server node arrangement 20. It is preferred that the access is made via the communication network arrangement 50b. The “access” includes both the situation when the client device 10b accesses a new information resource unit and the situation when the client device 10b accesses a media content or similar within a currently accessed information resource unit. In case of Web-pages, the “access” includes both the situation when the client device 10b accesses a new web-page, and the situation when the client device 10b accesses a first media content or a subsequent media content or similar within a currently accessed Web-page.

In a third step S3 of the exemplifying method it is preferred that the server node arrangement 20 or similar comprising the accessed information source unit 23 sends a reply to the client device 10b via the communication network 50b or similar.

The reply from the server node 20 or similar may e.g. comprise information items related to one or several of the following:
The name or identity or similar indicative of a media content 32b that is associated with or comprised by the accessed information source unit 23. This may e.g. be the identity or similar of a video or other multimedia item to be played. Information about the media content 32b may be provided in the form of a Media Content ID
Information about the media player(s) supported by the accessed information source unit 23, e.g. the accessed Web-page or similar. Information about the media player may be provided in the form of one or several Media Player ID indicative of the supported media player(s).

A media player may e.g. be implemented by means of software configured to play multimedia files or similar. Examples of well known media players are: Adobe Flash Player (Adobe Systems Inc.); iTunes (Apple Inc.); Quick Time (Apple Inc.); Windows Media Player (Microsoft Corporation). As is well known to those skilled in the art there are may other well known media players of the same or similar kind as those now mentioned.

It may be clarified that the Media Player ID mentioned above may comprise information indicative of the name of the supported media player(s), e.g. such as the names “Adobe Flash Player”, “iTunes”, “Quick Time” or indicators of such names or similar.

Alternatively or additionally, the Media Player ID may be indicative of a Media Player Set-Up Data that defines the properties and/or set-up of the supported media player(s). The Media Player Set-Up Data will then be retrieved from the control node arrangement 40 in steps S8-S9 as will be described later. Here, it is also preferred that the Media Player ID indicates the Media Content ID or similar mentioned above. The Media Content ID will then be retrieved from the control node arrangement 40 in steps S8-S9 as will be described later. Thus, the Media Content ID may be indirectly indicated, e.g. by the Medial Player ID or some other identifier or similar associated with the Media Content ID.

In addition, it is preferred that the reply from the server node 20 or similar comprises information items in the form of one or several scripts or similar. A script may e.g. comprise a list of instructions or similar that can be executed by the receiving client device 10b, preferably without user interaction, e.g. executed by a web-browser or similar comprised by the software 10b′. A script may e.g. be written in the scripting language JavaScript or similar.

In a fourth step S4 it is preferred that the script(s) received from the server node arrangement 20 in the third step S3 is executed by the client device 10b.

The script(s) may e.g. instruct the client device 10b to obtain information items related to the properties of the client device 10b, e.g. one or several of the following:
The Operating System (OS) used by the client device 10b. This may e.g. be any OS from Microsoft Corporation such as any Windows version, or any OS from Apple Inc. such as any Mac OS X version, or any OS from Symbian Ltd. Such as any version of Symbian OS etc.;
Additional software and/or hardware resources and/or properties supported and/or comprised by the device 10b;
The current address at which the client device 10b can be reached in the network arrangement 50b, e.g. the IP-address currently allocated to the client device 10b;
The bandwidth currently supported by or allocated to the client device 10b;
The current geographic location of the client device 10b, e.g. retrieved by the device from an internal GPS-function or similar, or retrieved from the core network in case of a cell phone.

In a fifth step S5 it is preferred that the client device 10b requests a suitable media player 41 to be used when eventually playing the media content 32b identified in step S3. Preferably, the request is directed to the control node arrangement 40. However, the request may alternatively be directed to the media node arrangement 30b or to the server node arrangement 20 or to any other suitable node that comprises the suitable media player 41. This has been schematically indicated by round dots on the S5 and S6 lines in FIG. 3 connecting the lines to the nodes 20, 30b and 40 respectively. The request can be communicated via the communication network arrangement 50b. The request may comprise any combination of the information items received in step S3 and/or information items retrieved in step S4.

A suitable media player 41 may then be selected by the control node arrangement 40 or the node arrangements 20 or 30 or any other suitable node as may be the case. It is preferred that the selection depend on the information items provided in the request step S5, e.g. information items received in step S3 and/or on information items retrieved in step S4.

In a sixth step S6 it is preferred that the client device 10b receives the suitable media player 41 from the control node arrangement 40, or the media node arrangement 30b as may be the case. It is preferred that media player 41 is received via the communication network arrangement 50b.

Requesting and receiving a media player as described above makes it unnecessary to select and preinstall a media player on the client device 10b. In addition, it makes it possible to provide the client device 10b with the most suitable media player 41 at each instance of the accessing of various information resource units 23. This improves the probability that the most appropriate media content can be selected and provided to the client device 10b. This is particularly so in case the media player is requested from the control node 40, which can be set up to select and deliver the most suitable media player depending on the available media content 32b in the media node 30b. This enables an improved handling of possible obsolete and/or inactive sources (e.g. obsolete and/or inactive media content). For example, various information resource units 23 (e.g. web pages) may remain unchanged, whereas the media player selected as a consequence of an access of an information resource unit 23 may be altered by simply amending the set up of the control node 40.

For example, a first media player may be selected when a first information resource unit 23 is accessed (an identifier of the accessed unit 23 may e.g. be provided in the request to the control node 40), and another media player may be selected when second information resource unit 23 is accessed. An access of the first information resource unit (e.g. a web page) may e.g. result in the selection of a more advanced media player, whereas an access of the second information resource unit may result in the selection of a less advanced media player etc. In another example, different media players may be selected depending on the versions of the media content being available at the media node 30b (information indicating the availability of media content at the media node 30b may e.g. be comprised by the information carrying unit 46 of the control node 40). A high resolution version may e.g. require a more advanced media player, whereas a low resolution version may require a less advanced media player etc. This provides a simple central updating of the selection of a suitable media player, which selection is substantially independent of the properties of the accessed information resource units. Similar advantages can be achieved at the selection of the media content version-properties in step S10 below.

In a seventh step S7 it is preferred that the client device 10b requests a Media Player Set-Up Data for the media player received in step S6 as described above. The request comprises any combination of the information items received by the reply in step S3 and/or retrieved by the script in step S4. It is particularly preferred that the request comprises the Media Player ID or similar. The request may also comprise other information that the client device 10b may append based on its internal operation being controlled by the software 10b′ or similar. The request in the present step S7 is preferably directed to the control node arrangement 40, preferably via the communication network arrangement 50b.

In an eighth step S8 it is preferred that the client device 10b receives the Media Player Set-Up Data for the media player received in step S6 from the control node arrangement 40. In case the Media Player ID received in step S3 also indicates the Media Content ID it is preferred that the client device 10b also receives the Media Content ID from the control node arrangement 40. It is preferred that the control node arrangement 40 selects and transmits the Media Player Set-Up Data and a possible Media Content ID depending on the Media Player ID and/or the other information provided by the request in step S7 above. The Media Player Set-Up Data is then executed by the client device 10b so as to set up the media player received in step S6 accordingly.

The observant reader realizes that providing the client device 10b with Media Player Set-Up Data makes it possible for the control node arrangement 40 to dynamically control the operation of the media player within the client device 10b depending on the Media Player ID and/or the other information provided by the request in step S7 above. This is possible even if the operator and/or owner of the control node arrangement 40 has little or no other association and/or control over the client device 10b and/or the media node 30b.

In a ninth step S9 it is preferred that the client device 10b requests information about any suitable versions 32b1, 32bn of the media content 32b directly or indirectly identified in the reply from the server node 20 in step S3. The request is directed to the control node arrangement 40, preferably via the communication network arrangement 50b. It is preferred that the request comprises the Media Content ID or similar being indicative of the identified media content 32b.

In addition, it is preferred that the request also comprises one or several further information items received in the reply in step S3 and/or retrieved by the script in step S4. The request may also comprise other further information items that the client device 10b may append based on its internal operation being controlled by the software 10b′ or similar.

When the control node arrangement 40 has received the media content request from the client device 10b it may readily obtain and select information about properties of the suitable versions 32b1-32bn of the identified media content 32b from the databases or similar information carrying units 46 comprised by the control node arrangement 40. It is preferred that the determination of the suitable versions 32b1-32bn and/or its version-properties are based on the information items in the request from the client device 10b received by the control node arrangement 40.

For example, a first set of suitable versions and their version-properties may be determined by the control node 40 selected when a first information resource unit 23 (e.g. a web page) is accessed (an identifier of the accessed unit 23 may e.g. be provided in the request to the control node 40), and another set of suitable versions and their version-properties may be selected when a second information resource unit 23 is accessed. This is so even if the same media content is requested which provides control of the media content versions offered by the control node. For example, high resolution versions of certain requested media content may be offered when a first web page is accessed, whereas low resolution versions of the same media content may be offered when a second web page is accessed.

In a tenth step S10 it is preferred that the control node arrangement 40 transmits and that the client device 10b receives the version-properties of the suitable versions 32b1, 32bn of the media content 32 identified by and requested from the control node arrangement 40. The transmission is preferably made via the communication network arrangement 50b. The version-properties of the suitable version 32b1, 32bn may e.g. comprise the address, the title or name, the file name, the file type, the file size and other properties of each version 32b1, 32bn such that the version can be identified and retrieved from a media node arrangement 30b as will be described later.

Receiving the version-properties of a number of suitable versions 32b1 to 32bn of the identified media content 32b provides the client device 10b with knowledge about the various suitable versions 32b1, 32bn available in a certain media node arrangement 30b. The client device 10b itself will then make a more precise selection of the most suitable of the available versions 32b1, 32bn. Indeed, this selection can be based on information held by the client device 10b that was not sent to, or comprised by the control node arrangement 40 or the media node arrangement 30b. However, it may in addition or alternatively be based on any combination of the information items received or obtained in steps S3 and/or S4.

This increases the probability that the client device 10b obtains the most suitable version of the requested media content 23b, even if insufficient information was provided to the media node arrangement 30b and/or the control node arrangement 40. In addition, this reduces the risk that the client device 10b requests a version 32b1, 32bn from an obsolete and/or inactive address or inactive source, since the address of the version may be appropriately updated at one central place, i.e. in the control node arrangement 40 as the address or source changes.

In an eleventh step S11 it is investigated if the identified media content 32b should be played by the client device 10b. This may for example be done by the client device 10b posing a question to the user of the client device 10b, e.g. via a display of the client device 10b. The user may e.g. answer the question by pushing a button on a keypad or similar of the client device 10b. The method proceeds to the next step S12 if the media content 32b should be played. It is preferred that the method stays idle at step S11 until it is interrupted. The method may e.g. be interrupted by the user pushing a button or otherwise actuates the client device 10b indicating that the media content 32b should be played as previously described, or by the user actuating the client device 10b so as to indicate that the method should be interrupted and ended. Any other method may be used for interrupt the method at the idle step S11, e.g. a time out function that interrupts and ends the method such that no media content is played if the user of the client device 10b has not pushed any button or similar within a certain period.

In a twelfth step S12 it is preferred that the client device 10b requests the most suitable of the available versions 32b1, 32bn selected by the client device 10b in step S10 above. The request is directed to the media node arrangement 30b, preferably via the communication network arrangement 50b. The request comprises one or several of the version-properties of the selected version 32b1, 32bn. The request may also comprise any combination of the information items received in step S3 and/or retrieved in step S4. In addition, the request may comprise other information that the client device 10b may append.

In a thirteenth step S13 of the exemplifying method it is preferred that the client device 10b receives a playable form of the selected most suitable of the versions 32b1, 32bn from the media node arrangement 30b, e.g. the version 32b1. Then a playable form is a form of the selected version 32b1 that is adapted to be played by the requesting client device 10b, preferably using the media player received in step S6.

In a fourteenth step S14 of the exemplifying method it is preferred that the client device 10b plays the received playable version of the selected most suitable of the versions 32b1, 32bn.

The present invention has now been described with reference to exemplifying embodiments. However, it should be understood that the present invention is not limited to the embodiments described and illustrated herein. On the contrary, the skilled person will recognize that many changes and modifications may be made within the scope of the appended claims.

We claim:

1. A method for providing a playable media content to a client device (10b), which method comprises the steps of:
sending a request for a media content (32b) from the client device (10b) to a control node arrangement (40),
determining in the control node arrangement (40) one or several suitable version (32b1, 32bn) of the requested media content (32b),
receiving in the client device (10b) from the control node arrangement (40) information indicating said determined version (32b1, 32bn),
selecting in the client device (10b) one of the determined versions (32b1, 32bn),
sending a request for the selected version from the client device (10b) to a media node arrangement (30b),
receiving in the client device (10b) from the media node arrangement (30b) a playable form of the selected version.

2. The method according to claim 1 comprising the additional steps of: accessing an information resource unit (23) by the client device (10b), and receiving in the client device (10b) information items from the information resource unit (23).

3. The method according to claim 2 comprising the additional steps of:
sending the request for a media content (32b) from the client device (10b) to the control node arrangement (40) such that the request comprises said information items and/or information indicative of the properties of the client device (10b),
determining in the control node arrangement (40) one or several suitable versions (32b1, 32bn) based on said information items and/or said information indicative of the properties of the client device (10b).

4. The method according to claim 1 comprising the additional steps of: selecting in the client device (10b) one of the determined suitable versions (32b1, 32bn) based on the information items and/or information indicative of the properties of the client device (10b).

5. The method according to claim 1 comprising the additional steps of:
sending a request for a media player from the client device (10b) to the control node arrangement (40) such that the request comprises said selected version and/or said information items and/or information indicative of the properties of the client device (10b),
determining in the control node arrangement (40) a media player based on the selected version and/or the information items and/or the information indicative of the properties of the client device (10b),
receiving in the client device (10b) the determined media player from the control node arrangement (40).

6. The method according to claim 1 comprising the additional steps of:
sending a request for a media player set-up from the client device (10b) to the control node arrangement (40) such that the request comprises the information items and/or information indicative of the properties of the client device (10b),
determining a media player set-up in the control node arrangement (40) based on said information items and/or said properties,
receiving in the client device (10b) the determined media player set-up from the control node arrangement (40).

7. A client device (10b) configured to operatively play media content, which client device is further configured to operatively:
send a request for a media content (32b) to a control node arrangement (40),
receive information from the control node arrangement (40) indicating one or several suitable version (32b1, 32bn) of the requested media content (32b),
select one of the indicated suitable versions (32b1, 32bn),
send a request for the selected version to a media node arrangement (30b),
receive a playable form of the selected version from the media node arrangement (30b).

8. The client device (10b) according to claim 7 further configured to operatively:
access an information resource unit (23), and
receive information items from the information resource unit (23).

9. The client device (10b) according to claim 7 further configured to: operatively: send said request for a media content (32b) to the control node arrangement (40) such that the request comprises the received information items and/or information indicative of the properties of the client device (10b).

10. The client device (10b) according to claim 7 further configured to operatively: select one of the indicated suitable versions (32b1, 32bn) based on said information items and/or information indicative of the properties of the client device (10b).

11. The client device (10b) according to claim 7 further configured to operatively:
send a request for a media player to the control node arrangement (40) such that the request comprises the information items,
receive a media player from the control node arrangement (40).

12. The client device (10b) according to claim 7 further configured to operatively:
send a request for a media player set-up to the control node arrangement (40) such that the request comprises the information items and/or information indicative of the properties of the client device (10b), and
receive a media player set-up from the control node arrangement (40).

13. A control node arrangement (40) configured to operatively provide information to a client device (10b) indicative of versions of a media content, which control node arrangement (40) is further configured to operatively:
receive a request for a media content (32b) from the client device (10b),
determining one or several suitable version (32b1, 32bn) of the requested media content (32b),
send information to the client device (10b) indicative of the determined suitable versions (32b1, 32bn).

14. The control node arrangement (40) according to claim 13 further configured to operatively:
receive said request comprising information items from an information resource unit (23) previously accessed by the client device (10b) and/or information indicative of the properties of the client device (10b),
determine the suitable versions (32b1, 32bn) based on said information items and/or said information indicative of the properties of the client device (10b).

15. The control node arrangement (40) according to claim 13 further configured to operatively:
receive a request for a media player from the client device (10b) comprising said selected version and/or information items from an information resource unit (23) previously accessed by the client device (10b) and/or information indicative of the properties of the client device (10b),
determine a media player based on the selected version and/or the information items and/or the information indicative of the properties of the client device (10b), and
send the determined media player to the client device (10b).

16. The control node arrangement (40) according to claim 15 further configured to operatively:
receive a request for a media player set-up from the client device (10b) comprising information items from an information resource unit (23) previously accessed by the client device (10b) and/or information indicative of the properties of the client device (10b), and
determine a media player set-up based on said information items and/or said information indicative of the properties of the client device (10b), and
send the determined media player set-up to the client device (10b).
